(19) United States
(12) Patent Application Publication
(10) Pub. No.: US 2002/0027664 A1
(43) Pub. Date: Mar. 7, 2002

(54) Method and apparatus for optical position detection

(76) Inventors: Robert W. Hyers, Huntsville, AL (US); Larry L. Savage, Central, SC (US); Jan R. Rogers, Grant, AL (US)

Correspondence Address: James J. McGroary, NASA/Marshall Space Flight Center, LS01/Office of Chief Counsel, MSFC, AL, 35812, US

(21) Appl. No.: 09/954,310

(22) Filed: Sep. 7, 2001

Related U.S. Application Data
(60) Provisional application No. 60/230,836, filed on Sep. 7, 2000.

(51) Int. Cl. G01B 11/24

(52) U.S. Cl. 356/614

(57) ABSTRACT

An apparatus and method for optically detecting the position of an object wherein an incandescent light source is used for illuminating the object. Condensing and collimating optics are provided for illuminating the object with a highly spatially uniform beam of substantially collimated light. Focusing optics focus the shadow of the object onto a light-sensitive position detector that produces an output signal indicative of the position of the shadow on the detector.

### CROSS-REFERENCE TO RELATED APPLICATIONS

The present application claims the benefit of the filing date of U.S. Provisional Patent Application Serial No. 60/230,836 filed Sep. 7, 2000.

### ORIGIN OF THE INVENTION

This invention was made by employees of the United States Government and may be manufactured and used by or for the Government for governmental purposes without the payment of any royalties.

### FIELD OF THE INVENTION

The present invention relates to apparatus and methods for optically detecting the position of an object by illuminating the object with light and detecting the position of a shadow cast by the object.

### BACKGROUND OF THE INVENTION

Optical position detection as described above is used in a variety of applications. As one example, optical position detection is used in electrostatic levitation devices used for levitating an object, such as a droplet of liquid, in order to enable a closed-loop control of the positioning of the object. Electrostatic levitation devices can be used for performing experiments and producing materials in the micro gravity of space as well as on Earth. In addition to the field of electrostatic levitation, there are many other fields in which it is desirable to be able to determine the position of an object with great accuracy.

In many prior optical systems for detecting the position of an object, lasers have been used for illuminating the object and casting a shadow onto a position sensing detector (PSD). Lasers are advantageous because they produce highly collimated light beams of high intensity such that the shadow cast by the object is a faithful actual-size representation of the object's outline. However, lasers are generally poor in terms of spatial uniformity and spatial and temporal stability. With respect to spatial uniformity, a laser beam spot generally contains bright and dark spots, sometimes referred to as “speckle.” This is a problem because the outline of the object on a position detector can be indistinct or ambiguous if the outline falls on areas of dark spots. With respect to spatial and temporal stability, lasers have the unfortunate characteristic that the intensity of their output depends strongly on their temperature, which can shift during operation and thus cause the beam intensity to shift, which is undesirable. Diode lasers are particularly susceptible to so-called “mode hopping” wherein at certain critical temperatures a large change in brightness can occur with very small changes in temperature.

It would be desirable to provide an apparatus and method that could reduce or overcome these drawbacks of prior optical position detecting systems.

### SUMMARY OF THE INVENTION

The present invention addresses the above-noted needs and achieves other advantages by providing an apparatus and method for optically detecting the position of an object wherein an incandescent light source is used for illuminating the object. Condensing and collimating optics are provided for illuminating the object with a highly spatially uniform beam of substantially collimated light. Focusing optics focus the shadow of the object onto a light-sensitive position detector that produces an output signal indicative of the position of the shadow on the detector.

The incandescent light source has very good temporal stability because the intensity of the light it produces can be regulated very accurately by controlling the power supplied to it. In a preferred embodiment of the invention, a DC voltage supply provides the power to the light source. The DC voltage supply can be very accurately regulated so that no shift or drift in its voltage occurs over time, and thus the intensity of the light produced is essentially constant.

Various types of optics can be used for condensing and collimating the light from the incandescent light source, including lenses and/or mirrors. Likewise, various types of optics can be used for focusing the shadow of the object onto the position detector.

The position of an object along each of two different axes can be detected in accordance with the invention, by providing two sets of light sources and position detectors respectively arranged along the two axes.

The invention enables substantially improved accuracy and reliability of position detection over laser-based systems by virtue of the ability to precisely control the intensity of the light and achieve a high degree of spatial uniformity. Furthermore, the cost of an incandescent light source is substantially lower than that of a laser.

### BRIEF DESCRIPTION OF THE DRAWINGS

The above and other objects, features, and advantages of the invention will become more apparent from the following description of certain preferred embodiments thereof, when taken in conjunction with the accompanying drawings in which:

FIG. 1 is a schematic side elevation, partly in section, of an apparatus in accordance with one preferred embodiment of the invention;

FIG. 2 is a side elevation of the projector supported by a mount, partially broken away to show the incandescent light source;

FIG. 3 is a top view of the projector and mount of FIG. 2;

FIG. 4 is a cross-section taken along line 4-4 of FIG. 3;

FIG. 5 is a side elevation of the detector assembly supported by a mount;

FIG. 6 is a top view of the detector assembly and mount of FIG. 5;

FIG. 7 is a cross-section taken along line 7-7 of FIG. 6; and

FIG. 8 is a schematic view of another apparatus in accordance with the invention for detecting the position of an object along each of two axes.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

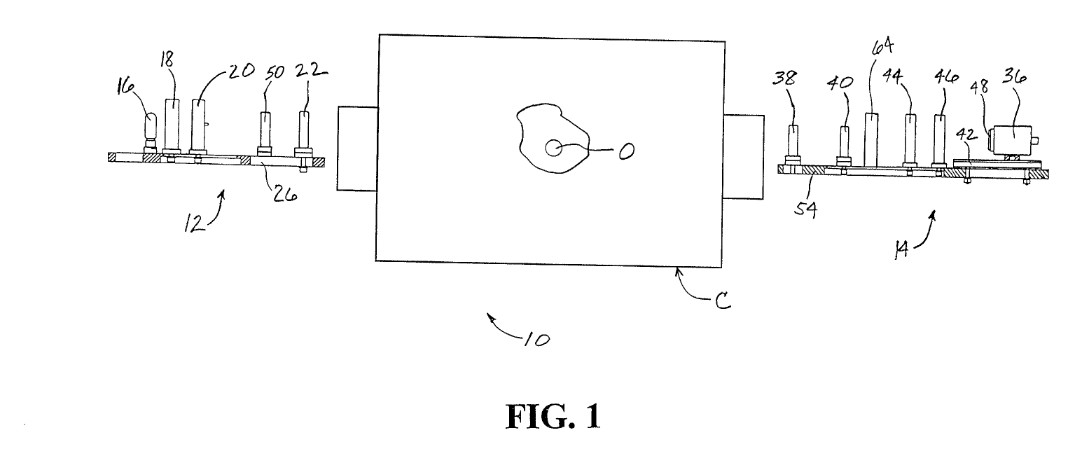

With reference to FIG. 1, an apparatus 10 in accordance with one preferred embodiment of the invention is depicted. The apparatus 10 comprises a projector 12 and a detector assembly 14 arranged on opposite sides of an object O whose position is to be detected. In the particular embodiment shown in FIG. 1, the apparatus 10 is shown being used in conjunction with a vacuum chamber C in which the object O is contained; a wall of the chamber is shown partially broken away from reveal the object inside. The object is levitated within the chamber by levitation devices (not shown), which do not form a part of the present invention and hence are not described herein.

The projector 12 includes an incandescent light source 16. Various types of incandescent light sources can be used with the present invention. An example of a suitable source is a halogen light bulb, which produces a high-intensity light. The projector 12 also includes condensing and collimating optics between the light source 16 and the object O for condensing and collimating the light from the light source so that the object is illuminated with a substantially collimated beam of light. In the illustrated embodiment, the condensing and collimating optics include a pair of aspheric lenses 18, 20 that collimate the light, and an achromatic lens 22 that directs the collimated light out of focus onto the object O. The light is directed out of focus so as to improve the spatial uniformity of the light illuminating the object. The result is a beam that is substantially collimated and having a high degree of spatial uniformity.

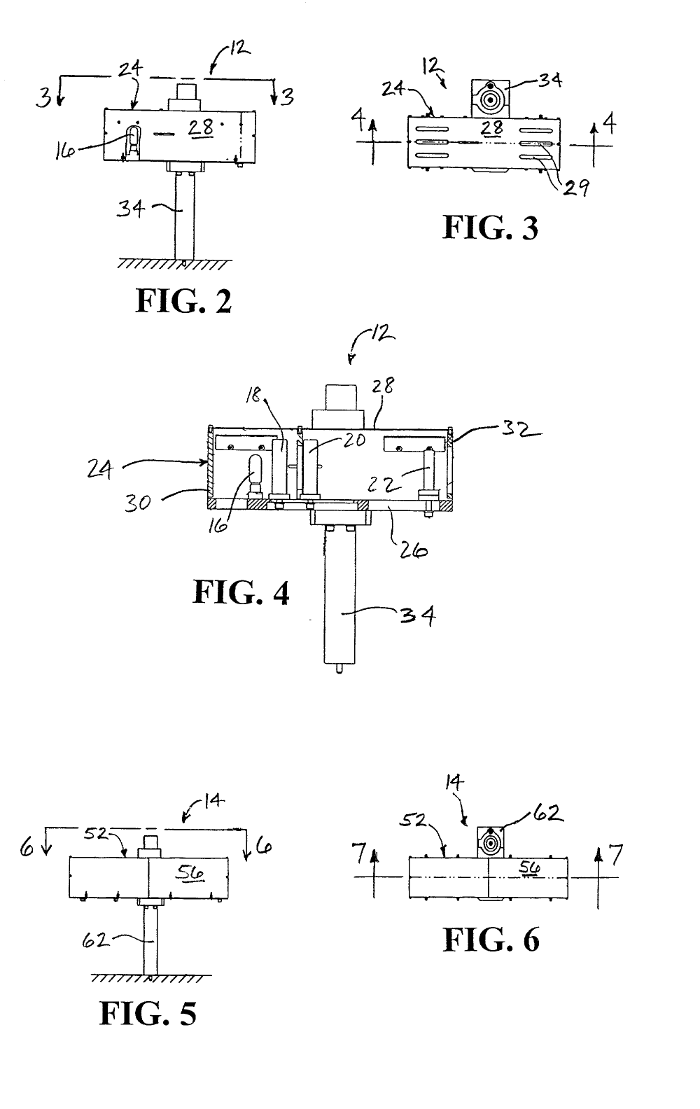

The various components of the projector preferably are mounted in a housing 24 as shown in FIGS. 2 through 4. The housing includes a base plate 26 on which the light source and optical elements 18, 20, 22 are mounted in coaxially aligned positions. The housing also includes a cover 28 of generally U-shaped configuration that attaches to the base plate 26 to form a generally tubular structure, and rear and front end walls 30, 32 that close the opposite ends of the tubular structure. The front end wall 32 defines an aperture through which the light beam is emitted. The cover 28 preferably includes ventilation openings 29. In the illustrated embodiment, the projector 12 is supported by a mount 34 that is affixed to a suitable support surface. If desired, the mount for the projector and/or the support surface can be operable to adjust the position of the projector 12 in one or more directions.

Optical elements other than the described aspheric lenses 18, 20 and achromatic lens 22 can be used in accordance with the invention. As known to persons skilled in the art of optics, mirrors generally can be used in place of lenses, and combinations of lenses and mirrors can also be used. The present invention is not limited to any particular types of optical elements for condensing and collimating the light from the incandescent light source.

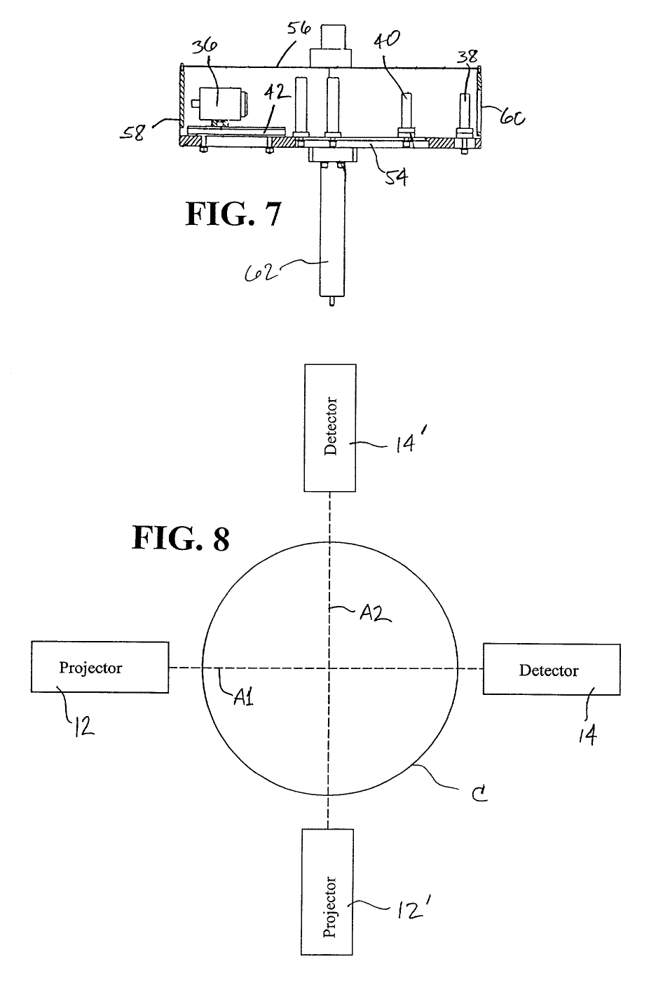

The detector assembly 14 is now described with reference to FIGS. 5 through 7. The detector assembly includes a light-sensitive position detector 36. The position detector is operable to provide an output signal that is indicative of a position of a shadow cast onto it. The position detector can be, for example, a p-n junction silicon semiconductor device that outputs voltages Vₓ and V_{y} that are proportional to the X and Y positions of the shadow on the face of the detector, which voltage signals are sent to a processor that computes the position of the shadow. In the case of a symmetric object O such as a sphere, the position of the shadow may be described in a simple manner such as the position of the center of the shadow. For more complex objects, the edge of the shadow may require definition at multiple points therealong in order to be able to determine the position and orientation of the object. In this case, it may be advantageous to employ a position detector having an array of light-sensitive independent pixels, such as a charge-coupled device (CCD), so that the full definition of the shadow can be determined based on pixels located at points of transition from dark to light, as known in the art. The invention is not limited to any particular type of position detector.

The detector assembly 14 further includes focusing optics for focusing the shadow of the object onto the light-sensitive face of the position detector 36. In the illustrated embodiment, the focusing optics include a pair of achromatic lenses 38, 40 having appropriate predetermined focal lengths and being mounted an appropriate predetermined distance apart to focus the collimated light onto the detector face located a predetermined distance downstream of the second lens 40. Preferably, the detector 36 is mounted on rails 42 that extend parallel to the optical axis so that the position of the detector can be adjusted relative to the focusing optics 38, 40 in order to permit the shadow of the object to be sharply focused onto the detector face.

The detector assembly optionally can also include one or more elements for attenuating the light reaching the detector 36. It may be desirable, for example, to use a light source 16 of higher intensity and then to attenuate the light before it reaches the detector so that the light striking the detector does not overdrive or saturate the detector; this type of arrangement can provide increased contrast of the image. In the illustrated embodiment, the attenuation is provided by a pair of polarizers 44, 46. Advantageously, one or both of the polarizers can be rotatable about the optical axis so that a variable degree of attenuation can be achieved by changing the relative rotational positions of the polarizers. Other types of attenuation devices could be used instead of the polarizers.

The detector assembly optionally can further include a filter 48 upstream of the position detector 36 for preventing undesirable light wavelengths from entering the detector. For instance, it may be desirable to filter out stray light rays from sources other than the light source 16. Additionally or alternatively, one or more filters 50 can optionally be included in the projector 12 to limit the spectrum that is emitted by the projector. The illustrated filter 50 can be, for instance, a band pass filter for reducing interference with other optical instruments that may be in use in the vicinity of the apparatus 10.

Another advantage of using an attenuator 44, 46 between the object O and the detector 36 is that incandescent objects can be imaged, regardless of the brightness of the object, as long as the light provided by the projector is brighter than the object at some wavelength or range of wavelengths. Then, the downstream attenuator can reduce the total optical signal (projector and object combined) to an intensity level that can be handled by the detector. The filter 48 can restrict the light reaching the detector to the wavelength or range of wavelengths at which the projector is brighter than the object.

The various components of the detector assembly 14 are mounted in a housing 52 that includes a base plate 54, a cover 56, and end walls 58, 60 similar to the housing for the projector. The front end wall 60 includes an aperture for admitting the collimated light from the projector. The detector assembly in the illustrated embodiment is supported on a mount 62 that is affixed to a suitable support surface.

The detector assembly 14 can also optionally include a beam-splitting device 64 (FIG. 1) such as a beam splitter or cold mirror for splitting the projector beam and directing a split beam out a suitable aperture in the cover of the detector assembly for other purposes. For instance, it may be desirable to use the split beam for displaying an image of the object, such as for monitoring the shape of a droplet of liquid levitated in the chamber C.

The apparatus 10 described above is useful for detecting the position of an object in a two-dimensional plane normal to the optical axis along which the collimated light is directed. However, the principles of the invention can also be applied for detecting the position of an object in three-dimensional space, as shown in FIG. 8. To this end, a first projector 12 and first detector assembly 14 are arranged along a first axis A1 on opposite sides of a chamber C containing the object whose position is to be detected. A second projector 12′ and second detector assembly 14′ are arranged on opposite sides of the chamber along a second axis A2 that is generally perpendicular to the first axis. In this manner, the outputs from the two detectors can be used to determine the three-dimensional position of the object.

In accordance with the invention, the intensity of the light source 16 can be controlled very accurately and without problems of mode-hopping and temperature-dependency that occur with lasers. More particularly, the light source preferably is powered by a DC voltage source (not shown) whose output voltage is regulated by a suitable voltage regulator. An incandescent light bulb powered by such a regulated DC voltage source exhibits very good stability even when the temperature of the light source varies. The intensity of the light is essentially independent of temperature, and depends virtually exclusively on the output voltage from the DC voltage source.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus for optically detecting the position of an object, comprising:
an incandescent light source for illuminating the object;
condensing and collimating optics between the light source and the object, the condensing and collimating optics acting on the light from the light source so as to form a substantially collimated light beam that illuminates the object;
a position detector located on an opposite side of the object from the light source and operable to receive the light beam from the condensing and collimating optics and to provide a signal indicative of a position of a shadow cast by the object onto the position detector; and
focusing optics between the object and the position detector for focusing the shadow of the object onto the position detector.

2. The apparatus of claim 1, wherein the condensing and collimating optics are structured and arranged to project the light out of focus onto the object.

3. The apparatus of claim 1, wherein the condensing and collimating optics comprise lenses.

4. The apparatus of claim 1, wherein the condensing and collimating optics include a pair of aspheric condensors.

5. The apparatus of claim 4, wherein the condensing and collimating optics further include an achromatic lens.

6. The apparatus of claim 1, further comprising at least one optical filter between the light source and the object.

7. The apparatus of claim 1, further comprising an attenuator between the object and the position detector.

8. The apparatus of claim 7, wherein the attenuator comprises a pair of sequentially arranged polarizers.

9. The apparatus of claim 8, wherein at least one of the polarizers is rotatable for providing variable attenuation of the light striking the position detector.

10. The apparatus of claim 1, further comprising a filter disposed between the object and the position detector.

11. The apparatus of claim 1, further comprising an element disposed between the object and the position detector for splitting the light beam and directing a split beam for other analysis.

12. The apparatus of claim 1, wherein the light source comprises a halogen lamp.

13. A method for optically detecting the position of an object, comprising:
directing light from an incandescent light source toward the object;
operating upon the light from the light source so as to collimate the light and illuminate the object with the collimated light such that the object casts a shadow; and
focusing the shadow of the object onto a light-sensitive position detector operable to provide a signal indicative of a position of the shadow on the detector.

14. The method of claim 13, wherein the collimated light is directed onto the object out of focus so as to illuminate the object with light that spatially is substantially uniform in intensity.

15. The method of claim 13, wherein aspheric condensers are used for collimating the light from the light source.

16. The method of claim 13, further comprising filtering the light from the light source.

17. The method of claim 16, wherein the filtering is performed upstream of the object.

18. The method of claim 16, wherein the filtering is performed downstream of the object.

19. The method of claim 13, further comprising attenuating the light at a location between the object and the position detector.

20. The method of claim 13, wherein the object being imaged is an incandescent object, and wherein the projector emits light that is brighter than the incandescent object at at least one wavelength, and further comprising employing a filter between the object and the detector to restrict light reaching the detector to said at least one wavelength.

21. The method of claim 13, wherein the object being imaged is an incandescent object, and wherein the projector emits light that is brighter than the incandescent object at at least one wavelength, and further comprising employing an attenuator between the object and the detector to reduce the combined intensity of light from the projector and the object that strikes the detector.

22. An apparatus for optically detecting the position of an object in three-dimensional space, comprising:
a first light source and a first light-sensitive position detector arranged on opposite sides of the object and aligned along a first axis;
a second light source and a second light-sensitive position detector arranged on opposite sides of the object and aligned along a second axis generally perpendicular to the first axis;
each of the first and second light sources comprising an incandescent light source;
condensing and collimating optics disposed between each of the light sources and the object for substantially collimating the light from the light source and illuminating the object with a collimated light beam directed parallel to the respective one of the first and second axes such that the object casts a shadow toward each of the position detectors; and
focusing optics disposed between each of the position detectors and the object for focusing the shadow onto each of the position detectors, each of the position detectors providing a signal indicative of a position of the shadow thereon.

23. The apparatus of claim 22, wherein the condensing and collimating optics along each axis direct the collimated light beam out of focus onto the object.
